(19) United States
(12) Patent Application Publication
(10) Pub. No.: US 2026/0070576 A1
(43) Pub. Date: Mar. 12, 2026

(54) LANE-CENTERING FEEDBACK FOR VEHICLES

(71) Applicant: QUALCOMM Incorporated, San Diego, CA (US)

(72) Inventors: Annika LARSSON, Mölndal (SE); Shabin MAHADEVAN, Lake Orion, MI (US)

(21) Appl. No.: 18/830,413

(22) Filed: Sep. 10, 2024

(51) Int. Cl. B60W 50/16; B60K 35/28; B60W 10/20; B60W 30/12; B60W 50/00; B60W 50/14

(52) U.S. Cl. CPC B60W 50/16; B60K 35/28; B60W 10/20; B60W 30/12; B60W 50/0097; B60K 2360/171; B60K 2360/1868; B60K 2360/188; B60W 2050/0083; B60W 2050/143; B60W 2050/146; B60W 2552/53

(57) ABSTRACT

Systems and techniques are described herein for providing lane-centering prompts to a driver. For instance, a method for providing lane-centering prompts to a driver is provided. The method may include obtaining a position of a vehicle relative to a lane in which the vehicle is travelling; obtaining contextual information related to the lane; determining a suggested position of the vehicle relative to the lane based on the contextual information; and providing, based on the contextual information, a recommendation to a driver of the vehicle, wherein the recommendation is based on the position of the vehicle and the suggested position of the vehicle.

### TECHNICAL FIELD

The present disclosure generally relates to lane-centering prompts. For example, aspects of the present disclosure include systems and techniques for providing lane-centering feedback for vehicles.

### BACKGROUND

A lane-keeping assist (LKA) feature of a driving system may determine a position of a vehicle relative to a lane in which the vehicle is travelling. For example, the LKA feature may obtain images captured by cameras of the vehicle and determine the position of the vehicle relative to the lane based on the images. In some aspects, the LKA feature may control steering of the vehicle, for example, to keep the vehicle in the lane or to keep the vehicle centered in the lane.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for providing lane-centering prompts to a driver. According to at least one example, a method is provided for providing lane-centering prompts to a driver. The method includes: obtaining a position of a vehicle relative to a lane in which the vehicle is travelling; obtaining contextual information related to the lane; determining a suggested position of the vehicle relative to the lane based on the contextual information; and providing, based on the contextual information, a recommendation to a driver of the vehicle, wherein the recommendation is based on the position of the vehicle and the suggested position of the vehicle.

In another example, an apparatus for providing lane-centering prompts to a driver is provided that includes at least one memory and at least one processor (e.g., configured in circuitry) coupled to the at least one memory. The at least one processor configured to: obtain a position of a vehicle relative to a lane in which the vehicle is travelling; obtain contextual information related to the lane; determine a suggested position of the vehicle relative to the lane based on the contextual information; and provide, based on the contextual information, a recommendation to a driver of the vehicle, wherein the recommendation is based on the position of the vehicle and the suggested position of the vehicle.

In another example, a non-transitory computer-readable medium is provided that has stored thereon instructions that, when executed by one or more processors, cause the one or more processors to: obtain a position of a vehicle relative to a lane in which the vehicle is travelling; obtain contextual information related to the lane; determine a suggested position of the vehicle relative to the lane based on the contextual information; and provide, based on the contextual information, a recommendation to a driver of the vehicle, wherein the recommendation is based on the position of the vehicle and the suggested position of the vehicle.

In another example, an apparatus for providing lane-centering prompts to a driver is provided. The apparatus includes: means for obtaining a position of a vehicle relative to a lane in which the vehicle is travelling; means for obtaining contextual information related to the lane; means for determining a suggested position of the vehicle relative to the lane based on the contextual information; and means for providing, based on the contextual information, a recommendation to a driver of the vehicle, wherein the recommendation is based on the position of the vehicle and the suggested position of the vehicle.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a representation of a vehicle traveling in a lane;

FIG. 2 is a block diagram illustrating an example system for providing recommendations to a driver of a vehicle, according to various aspects of the present disclosure;

FIG. 3 is a block diagram illustrating another example system for providing recommendations to a driver of a vehicle, according to various aspects of the present disclosure;

FIG. 4 is a block diagram illustrating yet another example system for providing recommendations to a driver of a vehicle, according to various aspects of the present disclosure;

FIG. 5 includes an example graphical representation of a recommendation, according to various aspects of the present disclosure;

FIG. 6 includes another example graphical representation of a recommendation, according to various aspects of the present disclosure;

FIG. 7 includes yet another example graphical representation of a recommendation, according to various aspects of the present disclosure;

FIG. 8 includes three example graphical representations of respective recommendations, according to various aspects of the present disclosure;

FIG. 9 includes an example representation of a recommendation, according to various aspects of the present disclosure;

FIG. 10 is a flow diagram illustrating an example process for providing lane-centering prompts, in accordance with aspects of the present disclosure;

FIG. 11 is a block diagram illustrating an example computing-device architecture of an example computing device which can implement the various techniques described herein;

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Various aspects relate generally to lane-centering prompts. Some aspects more specifically relate to generating, determining when to provide, and/or providing lane-centering prompts. In some examples, the systems and techniques may determine a position of a vehicle relative to a lane. Additionally, the systems and techniques may determine a desired position for the vehicle relative to the lane. The systems and techniques may determine a recommendation for moving the vehicle from the current position relative to the lane to the desired position relative to the lane.

Additionally, the systems and techniques may determine or obtain contextual information. The systems and techniques may determine whether and/or when to provide the recommendation to a driver of the vehicle based on the contextual information. In some instances, the systems and techniques may provide the recommendation. In some aspects, the recommendation may include an indication of the current position of the vehicle relative to a lane boundary.

Particular aspects of the subject matter described in this disclosure can be implemented to realize one or more of the following potential advantages. In some examples, by generating, determining when to provide, and/or providing lane-centering prompts, the described systems and techniques may improve safety of a vehicle. For example, the systems and techniques may prompt a driver to drive in a safer position relative to the lane in which the vehicle is traveling.

For example, the vehicle may be travelling near one edge of a lane. The driver of the vehicle may not be aware of where the vehicle is traveling relative to the lane. For example, the driver may not be familiar with a width of the vehicle. The systems and techniques may provide prompts that may aid the driver by prompting the driver to move to a center of the lane. Over time, such prompts may help the driver to become more aware of the width of the vehicle.

In some situations it may be safer to be driving closer to one side of the lane than the opposite side of the lane. In such situations, the systems and techniques may determine contextual information that may indicate that it is safer to travel closer to the one side of the lane. The systems and techniques may then forego providing recommendations to drive in the center of the lane. Alternatively, the systems and techniques may provide recommendations to drive on the one side of the lane.

Driving systems (e.g., autonomous, semi-autonomous, and/or assisted driving systems, such as an advanced driver assistance systems (ADAS)) of vehicles may assist a driver of a vehicle. Such driving systems may operate at various levels of autonomy. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action.

A lane-keeping assist (LKA) feature of a driving system (e.g., an ADAS) may determine a position of a vehicle relative to a lane in which the vehicle is travelling. For example, the LKA feature may obtain images captured by cameras of the vehicle and determine the position of the vehicle relative to the lane based on the images. In some aspects, the LKA feature may control steering of the vehicle, for example, to keep the vehicle in the lane or to keep the vehicle centered in the lane.

In some places, lanes of a road may be narrow. Further, some lanes may be perceived by a driver as especially narrow, for example, when the lanes are proximate to barriers (e.g., concrete barriers) or other obstacles. Some lanes have only a paint strip (e.g., a strip that may be 10 centimeters in width), with no extra space beyond the lane.

Such characteristics of lanes on roads may cause issues with driving behavior. For example, drivers may not be aware of where the sides of their vehicle are relative to the lane. When driving in a narrow lane, for example, some drivers may drive on the outside of the lane, forcing drivers of other vehicles in neighboring lanes to maneuver outside of their respective lane(s). Such behavior can this increase the risk of vehicular accidents, such as one vehicle sideswiping another vehicle. Guardrails, concrete barriers, lack of a hard shoulder, static objects, and dynamic objects can also cause drivers to drive near an edge of their lane. This problem is partly due to drivers not being sufficiently aware of where their vehicles are on the road (e.g., relative to their lanes).

Systems, apparatuses, methods (also referred to as processes), and computer-readable media (collectively referred to herein as “systems and techniques”) are described herein for providing lane-centering feedback for vehicle. For example, a vehicle can output lane-centering prompts to a driver of the vehicle. In some aspects, the systems and techniques may provide an indication of a position of a vehicle relative to a lane in which the vehicle is travelling. For instance, the systems and techniques may display a graphic illustrating a distance between wheels of a vehicle and lane boundaries (e.g., on both sides of the vehicle) or a video of a wheel of the vehicle in relation to a lane boundary. Providing such indications to a driver may prompt the driver to drive in a center of a lane. For example, the driver may not be aware of where their vehicle is relative to the lane and providing such information may inform the driver where their vehicle is relative to the lane, prompting the driver to steer their vehicle into the center of the lane. Over time, providing such indications to a driver may help the driver gain a more accurate awareness of their vehicle (e.g., of the width of their vehicle relative to the width of lanes).

The systems and techniques may display a video or illustration representative of the position of a vehicle relative to a lane. For example, the systems and techniques may capture a video including a tire of the vehicle and lane boundaries and display the video to a driver of the vehicle. Additionally or alternatively, the systems and techniques may determine a distance between a tire of the vehicle and a lane boundary and display a graphical representation of the distance to the driver. Additionally or alternatively, the systems and techniques may determine a distance between a centerline of the vehicle and a center of the lane and display a graphical representation of the distance to the driver.

In some aspects, the systems and techniques may determine when to provide recommendations (e.g., display video or graphical representations) based on contextual information. Additionally or alternatively, in some aspects, the systems and techniques may adapt to a driver to personalize recommendations based on preferences and/or responsiveness of the driver.

For example, the systems and techniques may determine a position of a vehicle relative to a lane, for example, using images captured by cameras of the vehicle. For instance, the vehicle may include one or more cameras positioned and oriented to capture images of the lane as the vehicle is travelling in the lane. The systems and techniques may determine the position of the vehicle relative to the lane based on the images.

The systems and techniques may determine contextual information and provide the indication of the position of the vehicle relative to the lane based on the contextual information. For example, in some circumstances, it may be desirable (e.g., safer) to travel closer to one edge of a lane than to the other. For instance, it may be safer to travel closer to one lane boundary than to the opposite lane boundary when a motorcycle is traveling between lanes, a vehicle is stopped on the side of the road, there is construction ongoing on the side of the road, the road is curved. Traveling closer to one lane boundary than to the opposite lane boundary may allow a vehicle to maintain a safe lateral distance to dynamic objects (e.g., large trucks, lane splitting motorcycles) in other lanes, to maintain safe lateral distance to obstacles (e.g., dropped cargo) in the other lane (or in the lane), to see further over other vehicles on the forward traffic horizon, to mimic a lead vehicle as it drifts to lane edge (probably reacting to possible threats), and/or to support a “Move Over” law when the adjacent lane is occupied, etc. In such situations, providing an indication of a position of the vehicle relative to the lane may be inappropriate (e.g., distracting, irritating, and/or not useful). The systems and techniques may determine contextual information and may determine when to display indications of a position of the vehicle relative to the lane based on the contextual information.

Determining when to provide indications of the position of the vehicle based on the contextual information may improve the appropriateness of providing indications to the driver. For example, a driver of a vehicle may be driving close to a boundary of a lane (e.g., closer to a left lane boundary than to the right lane boundary) because there may be a vehicle stopped on the side of the road (e.g., proximate to the right lane boundary). Driving closer to the boundary of the lane may be safer than driving in the center of the lane. Determining not to provide indications of the position of the vehicle based on the presence of objects or vehicles proximate to the lane may prevent the systems and techniques from providing indications that would encourage or prompt unsafe driving. Further, by not providing indications at inappropriate times, the systems and techniques may increase the impact of indications when provided at appropriate times. For example, if indications are provided at inappropriate times, a driver may come to ignore indications. If indications are provided at appropriate times, the driver may pay attention to the indications since the indications may help in developing a clear mental model about the indications for the driver.

In some situations, providing an indication to a driver may encourage the driver to look at, or pay attention to, a center of a lane rather than at an object or vehicle outside the lane. For example, prompting the driver to center their vehicle in the lane may draw the driver's attention to the lane and away from an accident on the side of the road. Drawing a driver's attention to their lane may be especially effective if the indication is presented at a heads-up display (HUD).

Additionally or alternatively, in some circumstances, the systems and techniques may recommend driving closer to an edge of a lane rather than in the center of the lane. For example, the contextual information may include information relative to construction or a stopped vehicle near one lane boundary. In such situations, the systems and techniques may recommend driving closer to the opposite lane boundary.

In various examples, the contextual information may be related to another vehicle in the lane (e.g., the lane in which the vehicle is travelling), another vehicle proximate to the lane (e.g., a vehicle in a lane adjacent to the lane in which the vehicle is travelling, including lanes for traveling in the same direction as the vehicle and lanes for travelling in the opposite direction as the vehicle, and/or a vehicle on the side of the road or on the shoulder of the road), an object (e.g., a rock, debris, or an animal) in the lane, an object proximate to the lane (e.g., in another lane or near or on the shoulder of the road), a field of view of the driver from the position relative to the lane (e.g., whether a portion of the driver's field of view is occluded by another vehicle or other object), a curvature of the lane, a speed of the vehicle, a speed limit related to the lane, an alertness of the driver, a manner in which the driver controls a steering wheel of the vehicle (e.g., whether the driver is grasping the wheel with both hands or lightly holding the wheel with one hand), a determined familiarity of the driver with the lane and/or route (e.g., based on a number of times the driver has driven on the road and/or how recently the driver has driven on the road), and/or conditions of respective tires of the vehicle (e.g., air pressure and/or wear on the tires).

Additionally or alternatively, the systems and techniques may determine a response of a driver to provided indications. For example, the systems and techniques may obtain images of the driver and determine how the driver responded to provided indications. For instance, the systems and techniques may determine, after an indication was provided, whether the driver looked at the indication, whether the driver looked at a side-view mirror of the vehicle, whether the driver changed the position of the vehicle relative to the lane, whether the driver looked at another vehicle proximate to the lane, whether the driver looked at an object proximate to the lane, and/or a facial expression of the driver. In some aspects, the systems and techniques may adjust parameters for providing future indications based on the response. For example, the systems and techniques may determine how to provide future indications based on the response of the driver to a provided indication. For example, if the driver looked at an indication and steered the vehicle to the center of the lane, the systems and techniques may determine that the indication was useful and adjust a parameter of the systems and techniques to cause the systems and techniques to continue to provide similar indications in similar situations. As another example, if the driver looked at the indication but did not change the position of the car relative to the lane, the systems and techniques may determine that the indication was not useful to the driver. The systems and techniques may adjust a parameter of the systems and techniques to cause the systems and techniques to be less likely to provide similar indications in similar situations.

To provide indications to the driver, the systems and techniques may, for example: illuminate a light source (e.g., a light-emitting diode (LED) or a light bulb) in an instrument panel of the vehicle, a telltale in the instrument cluster, display a visual indication (e.g., a graphical representation, images, or video, such as of the a tire of the vehicle relative to a lane boundary) at a display of the vehicle (e.g., on a console display of the vehicle), display a visual indication at a heads-up display of the vehicle (e.g., a display projected onto a windshield of the vehicle), illuminate a portion of the steering wheel of the vehicle (e.g., a portion corresponding to a direction to turn to center the vehicle in the lane), play audio (e.g. a tone, a chime, a gong, and/or a vocalization) using speakers of the vehicle, suppress other audio (e.g., of the infotainment system), pulse brakes of the vehicle, vibrate the steering wheel, pulse a seat belt of the vehicle, and/or vibrate a seat and/or steering wheel of the vehicle. In some aspects, the indication may be based on which lane boundary the vehicle is close to, or which direction the vehicle should move to be centered in the lane. For instance, the indication may be, or may include, causing the right side of the steering wheel or seat to shake to prompt the driver to move to the right (or left depending on predetermined settings). The intensity and/or frequency of the indications (or alerts) can increase (in isolation or in combination with other indications) if the driver continues to ignore an indicator and/or until lane departure warning/collision avoidance kicks in (e.g., when the tire crosses the lane boundary).

Some of the ways of providing the indication to the driver may be more aggressive (e.g., attention catching or noticeable) than others. For example, pulsing brakes of the vehicle may be more aggressive than providing a visual indication at a console display of the vehicle. In some aspects, the systems and techniques may determine a way to provide the indication based on the position of the vehicle relative to the lane boundary, the contextual information, and/or the response of the driver. For example, if the vehicle is far from a center of the lane (e.g., beyond one or more threshold distances from the center of the lane), the systems and techniques may provide a more aggressive indication than if the vehicle is close to the center of the lane (e.g., within a threshold distance from the center of the lane). Additionally or alternatively, the systems and techniques may provide a more aggressive indication when the vehicle is travelling at a higher speed as compared to when the vehicle is travelling at a lower speed. Additionally or alternatively, the systems and techniques may increase an aggressiveness of indications if the vehicle is out of the center of the lane for a period of time (exceeding a threshold) and/or if the vehicle is repeatedly (e.g., beyond a threshold number of times) out of the center of the lane. Additionally or alternatively, the systems and techniques may increase an aggressiveness of the indications if the driver appears drowsy, fatigued, and/or distracted (e.g., based on images of the driver and/or based on the driver correcting after indications, then drifting toward edges of lanes repeatedly).

The systems and techniques can provide the indication to the driver as a separate function from a lane-keeping assistance (LKA) function. In some aspects, the systems and techniques may perform an LKA function in addition to providing the indication. For example, the systems and techniques may take control of steering of the vehicle based on one or more factors. For example, if the vehicle is greater than a first threshold distance from the center of the lane, the systems and techniques may provide a first indication (e.g., a less aggressive indication). If the vehicle is greater than a second threshold distance from the center of the lane, the systems and techniques may provide a second indication (e.g., a more aggressive or a different type of indication). If the vehicle is greater than a third threshold distance from the center of the lane, the systems and techniques may initiate the LKA function and steer the vehicle toward the center of the lane.

In some aspects, the systems and techniques may provide the indication to an automated or semi-automated driving system. For example, in some aspects, an automated or semi-automated driving system may use recommendations from the systems and techniques to determine when to center the vehicle and when not to center the vehicle. For example, the automated or semi-automated driving system may use the recommendations from the systems and techniques to determine when it is not better to travel in the center of the lane. Additionally or alternatively, the automated or semi-automated driving system may use the recommendation from the systems and techniques to determine how to steer to move the vehicle to the center of the lane.

Various aspects of the application will be described with respect to the figures below.

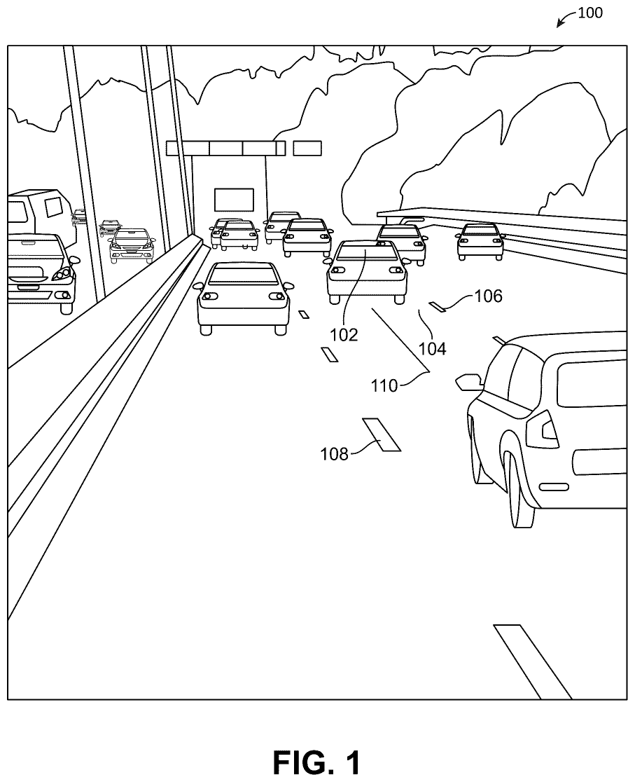

FIG. 1 is a representation 100 of a vehicle 102 traveling in a lane 104. Vehicle 102 is traveling closer to right lane boundary 106 than to left lane boundary 108. Additionally, a centerline of vehicle 102 is to the right of a lane center 110 of lane 104. Assuming vehicle 102 is not changing lanes, it may be useful to a driver of vehicle 102 to be informed of the position of vehicle 102 relative to lane 104.

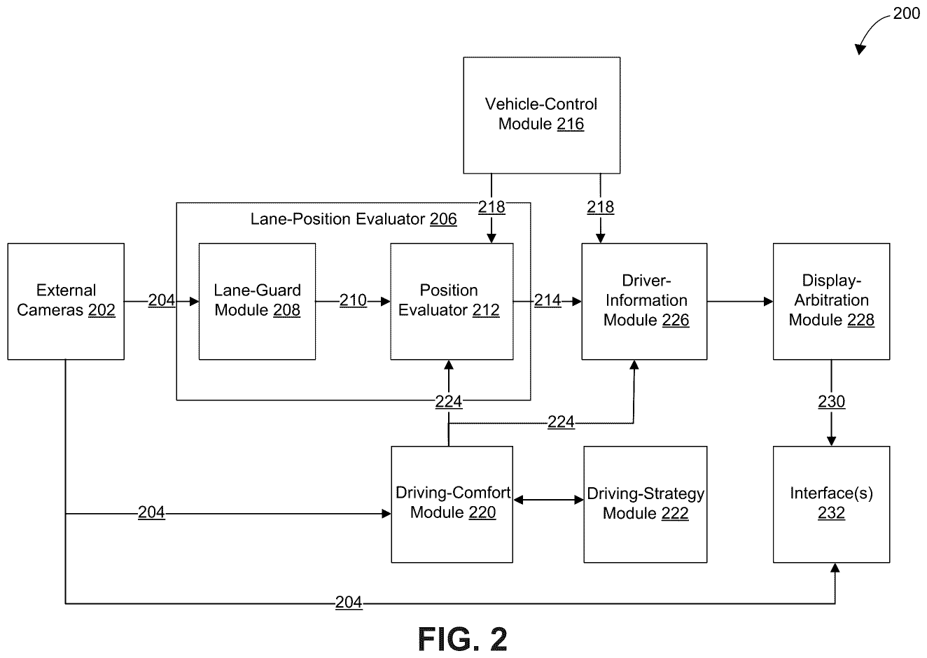

FIG. 2 is a block diagram illustrating an example system 200 for providing recommendations to a driver of a vehicle, according to various aspects of the present disclosure. In general, external cameras 202 of the vehicle may capture image data 204 which may include images including a road on which the vehicle is traveling. External cameras 202 may provide image data 204 to a lane-position evaluator 206. A lane-guard module 208 of lane-position evaluator 206 may determine a position of the vehicle relative to the lane and provide an indication of the position (“lane position 210”) to position evaluator 212. Vehicle-control module 216 may generate control data 218 based on how the driver controls the vehicle (e.g., using the steering wheel, accelerator, and/or brakes). A driving-comfort module 220 and a driving-strategy module 222 may determine contextual information 224 based on image data 204. A position evaluator 212 of lane-position evaluator 206 may determine an appropriateness of the lane position, for example, based on control data 218 and contextual information 224 from driving-comfort module 220. Position evaluator 212 may determine a recommendation 214 based on lane position 210 and the appropriateness of lane position 210 and provide recommendation 214 to driver-information module 226. Driver-information module 226 may manage information being presented to the driver. A display-arbitration module 228 may determine an indication 230 of recommendation 214 to the driver and provide indication 230 to one or more interface(s) 232 to be provided to the driver.

External cameras 202 may be, or may include, any number of cameras, or other sensors, of the vehicle that are directed outside the vehicle. External cameras 202 may include, for example, cameras on bumpers of the vehicle, on mirrors of the vehicle, on a roof of the vehicle, etc. Additionally or alternatively, external cameras 202 may include other sensors, such as, light detection and ranging (LIDAR) sensors and/or radio detection and ranging (RADAR) sensors. External cameras 202 may capture image data 204 representative of an environment of the vehicle. Image data 204 may include representations of the road on which the vehicle is traveling, including lane markings. Although referred to as image data 204, image data 204 may include point clouds, such as from a LIDAR sensor and/or RADAR sensor.

A lane-guard module 208 may determine a position of the vehicle relative to a lane in which the vehicle is traveling. For example, lane-guard module 208 may have information regarding where external cameras 202 are on the vehicle. Lane-guard module 208 may be able to determine, based on image data 204 and the information regarding where external cameras 202 are on the vehicle, a position of the vehicle relative to the lane. For example, based on an image from a camera positioned at a center of a front bumper of the vehicle, lane-guard module 208 may determine where the vehicle is relative to a lane in which the vehicle is traveling. Additionally or alternatively, based on images from side-view mirrors, lane-guard module 208 may determine a position of the vehicle relative to the lane.

Vehicle-control module 216 may include sensors measuring how a driver is controlling the vehicle. For example, vehicle-control module 216 may include sensors measuring steering data indicating, for example, an angle of the steering wheel, torque applied to the steering wheel, etc. Additionally or alternatively, vehicle-control module 216 may include sensors measuring accelerator data indicating, for example, pressure on an accelerator of the vehicle and/or a position of the accelerator. Additionally or alternatively, vehicle-control module 216 may include sensors measuring brake data indicating, for example, pressure on an brake pedal of the vehicle and/or a position of the brake pedal. Vehicle-control module 216 may provide the sensor data as control data 218 to position evaluator 212.

Driving-comfort module 220 and driving-strategy module 222 may determine a state of the vehicle including whether the driver should be actively steering and/or whether a lane-keeping assist (LKA) feature should take over. Additionally or alternatively, driving-comfort module 220 and/or driving-strategy module 222 may determine contextual information 224. For example, driving-comfort module 220 and/or driving-strategy module 222 may obtain image data 204 which may include images of other vehicles and/or object on the road and/or near the road. For example, external cameras 202 may include cameras facing in the direction that the vehicle is traveling, behind the vehicle, and/or to sides of the vehicle, all of which may capture images. Such images may include vehicles and/or objects on the road (including in the same lane as the vehicle, in lanes adjacent to the lane of the vehicles, objects in opposing lanes of traffic) and/or near the road (for example, on the shoulder). Driving-comfort module 220 and/or driving-strategy module 222 may determine contextual information 224 based on the images. Contextual information 224 may include position information indicating positions of other vehicles and/or objects. The position information may be relative to the vehicle and/or relative to the lane of the vehicle. For example, contextual information 224 may include an indication of another vehicle ahead of the vehicle in the lane of the vehicle, an indication of another vehicle in a lane adjacent to the vehicle, and an indication of yet another vehicle stopped on the side of the road. Additionally or alternatively, driving-comfort module 220 may determine a curvature of the road based on image data 204. Contextual information 224 may include an indication of the curvature of the road.

Position evaluator 212 may determine the appropriateness of lane position 210 of the vehicle relative to the lane based on contextual information 224. For example, position evaluator 212 may determine that an off-center position of the vehicle is appropriate in view of a vehicle overtaking the vehicle in the left lane or traffic in the right lane. As another example, position evaluator 212 may determine that lane position 210 of the vehicle is appropriate based on the curvature of the road. As another example, position evaluator 212 may determine that lane position 210 is inappropriate based on the absence of vehicles on the side of the road and the absence of vehicles passing.

Position evaluator 212 may determine recommendation 214 based on lane position 210, and the determined appropriateness of lane position 210. For example, in some circumstances, for instance when position evaluator 212 determines that lane position 210 is inappropriate based on contextual information 224, position evaluator 212 may determine recommendation 214 indicative of a recommendation to move the vehicle to the center of the lane. In other circumstances, for example, when position evaluator 212 determines that lane position 210 is appropriate, position evaluator 212 may not determine a recommendation 214 or may determine recommendation 214 indicating an instruction to maintain lane position 210.

As another example, generally, when a vehicle approaches a curve, being positioned just inside the right edge of the roadway is safe, as this will keep the vehicle as far away from oncoming traffic as possible. As the vehicle moves through the curve and reach the center point, the driver may adjust the position towards the center of the road (while staying inside the lane) to maximize view of the road ahead. This will also make the vehicle visible to oncoming traffic and minimize the amount of steering needed when moving out of the curve. Position evaluator 212 may determine recommendation 214 to nudge the driver towards such a behavior when approaching, maneuvering, and/or exiting a curve by generating recommendation 214 indicative of such behavior.

In some aspects, position evaluator 212 may determine recommendation 214 based at least in part on control data 218. For example, if control data 218 indicates that the driver is adjusting the steering of the vehicle, position evaluator 212 may not determine a recommendation 214. As another example, if control data 218 indicates that a turn signal is active, position evaluator 212 may not determine a recommendation 214.

Driver-information module 226 may manage information to be presented to the driver. For example, driver-information module 226 may manage information from other sensors and/or systems of the vehicle. For example, driver-information module 226 may manage warnings or alerts from tire-pressure sensors, gas-tank sensors, engine temperature sensors, etc. Driver-information module 226 may prioritize information and/or alerts to provide to the driver.

In some aspects, driver-information module 226 may receive recommendation 214 and control data 218 and/or contextual information 224. Driver-information module 226 may determine whether to provide indication 230 and/or what indication 230 to provide based on control data 218 and/or contextual information 224. For example, in some cases, position evaluator 212 may determine recommendation 214 indicative to move to a center of a lane. Based on contextual information 224 (e.g., which may indicate a passing vehicle or a road curvature), driver-information module 226 may determine to not generate and/or provide indication 230 based on recommendation 214. As another example, based on control data 218 indicating that the driver is turning, changing lanes, or adjusting a position of the vehicle within the lane, driver-information module 226 may determine to not generate and/or provide indication 230.

In some aspects, display-arbitration module 228 may determine indication 230 of recommendation 214 to the driver. For example, the vehicle may include one or more interface(s) 232. Interface(s) 232 may include, for example, displays (such as a center-stack display, a console display, a heads-up display (HUD)), speakers (e.g., of the vehicles sound system), and/or actuators (for example, positioned to vibrate, pulse, and/or shake, a seat of the driver, the steering wheel of the vehicle, the seatbelt of the driver, etc.). Display-arbitration module 228 may determine indication 230 to provide to the driver and how to provide indication 230 (e.g., which of interface(s) 232 to use). In some aspects, interface(s) 232 may display images or video from external cameras 202. For example, external cameras 202 may include a camera that may capture images or video of a wheel of the vehicle and a lane boundary. Interface(s) 232 may display such images or video as indication 230.

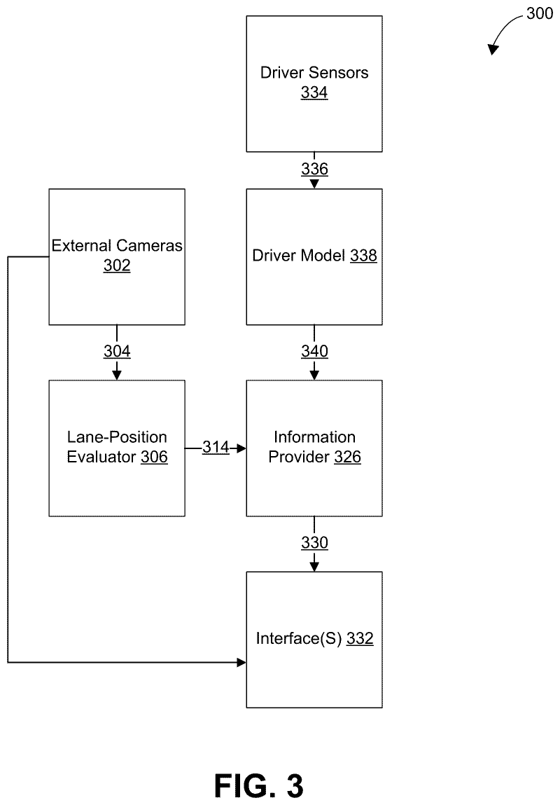

FIG. 3 is a block diagram illustrating an example system 300 for providing recommendations to a driver of a vehicle, according to various aspects of the present disclosure. In general, external cameras 302 may capture image data 304 including a road on which the vehicle is traveling. Lane-position evaluator 306 may determine a position of the vehicle relative to a lane in which the vehicle is traveling. Additionally, lane-position evaluator 306 may determine an appropriateness of the position of the vehicle and a recommendation 314 based on the position of the vehicle relative to the lane and the appropriateness of the position. Driver sensors 334 may generate driver data 336 based on the driver of the vehicle. Driver model 338 may determine driver information 340 based on driver data 336. Information provider 326 may determine indication 330 of recommendation 314 based on driver information 340 and provide indication 330 to interface(s) 332.

External cameras 302 may be the same as, may be substantially similar to, and/or may perform the same, or substantially the same, operations as external cameras 202 of FIG. 2. Image data 304 may be the same as, or may be substantially similar to, image data 204 of FIG. 2. Lane-position evaluator 306 may perform the same, or substantially the same, operations as lane-position evaluator 206 of FIG. 2. For example, lane-position evaluator 306 may perform operations described with regard to lane-position evaluator 206, lane-guard module 208, and/or position evaluator 212.

Driver sensors 334 may be, or may include, one or more sensors to generate driver data 336 based on the driver. Driver sensors 334 may include cameras pointed at the driver which may capture actions, an indication of a gaze of the driver, and/or facial expressions of the driver. Additionally or alternatively, driver sensors 334 may include vehicle-control sensors. For example, driver sensors 334 may be, or may include, sensors described with regard to vehicle-control module 216 of FIG. 2.

Driver model 338 may be, or may include, a model that may determine or predict driver information 340 based on driver data 336. Driver data 336 may include observable characteristics of the driver, for example, actions, gazes, and/or facial expressions. Driver information 340 may be, or may include, inferences based on driver data 336. For example, driver information 340 may be, or may include, inferences regarding an emotional state of the driver, a receptivity of the driver to recommendations, an attentiveness of the driver, a stress level of the driver, what the driver is looking at, etc. In some aspects, driver model 338 may be based on a specific driver. For example, driver model 338 may include information based on the specific driver, such as, a typical alertness of the driver, a level of experience of the driver, how the driver responds to different indications, which interfaces the driver looks at most often, where the driver typically drives relative to a lane, locations where the driver has driven before.

Information provider 326 may be the same as, may be substantially similar to, and/or may perform the same, or substantially the same, operations as driver-information module 226 of FIG. 2 and/or display-arbitration module 228 of FIG. 2. Indication 330 may be the same as, or may be substantially similar to, indication 230 of FIG. 2. Interface(s) 332 may be the same as, may be substantially similar to, and/or may perform the same, or substantially the same, operations as interface(s) 232 of FIG. 2.

For example, information provider 326 may determine indication 330 of recommendation 314 to present to the driver based on recommendation 314 and driver information 340. For example, information provider 326 may determine how or whether to provide recommendation 314 based on an attentiveness of the driver. For instance if the driver is inattentive, information provider 326 may determine to use an obvious and/or attention-grabbing method for providing indication 330 (e.g., a bright indication on a HUD). Alternatively, if the driver is attentive, information provider 326 may determine a more subtle method for providing indication 330 (e.g., a small graphic on a console display).

As an example of contemplated operations of system 300, external cameras 302 may provide image data 304 to lane-position evaluator 306. Lane-position evaluator 306 may determine the current position of the vehicle relative to a lane in which the vehicle is traveling. Lane-position evaluator 306 may determine whether the current position is risky. For example, lane-position evaluator 306 may determine whether the vehicle is a threshold distance from a lane center, or a lane boundary, or if the vehicle is moving toward a lane boundary at a rate that exceeds a threshold. If the current position is risky, then lane-position evaluator 306 may determine to provide recommendation 314 to information provider 326.

In some aspects, when determining recommendation 314 and/or determining whether the current position is risky, lane-position evaluator 306 may take contextual information into account. For example, lane-position evaluator 306 may receive contextual information 224 (e.g., from driving-comfort module 220 and/or driving-strategy module 222 of FIG. 2) and make determinations regarding recommendation 314 based on contextual information 224. For example, if there is another vehicle close to a boundary of the lane in which the vehicle is traveling, lane-position evaluator 306 may forego generating recommendation 314.

Additionally or alternatively, in some aspects, information provider 326 may take contextual information into account. For example, information provider 326 may receive contextual information 224 (e.g., from driving-comfort module 220 and/or driving-strategy module 222 of FIG. 2) and make determinations based on when and/or how to provide indication 330 of recommendation 314 based on the contextual information.

Further, information provider 326 may determine how to provide indication 330 of recommendation 314 based on driver information 340. For example, driver information 340 may indicate how often the driver looks at a console display and/or how often the driver responds to indications presented at the console display. Based on the driver looking at the console display infrequently (e.g., less often than a frequency threshold), information provider 326 may determine to present a low-risk indication 330 at the center console and to present a high-risk indication 330 at another display (e.g., a HUD), or using another mode (e.g., using speakers of the vehicle). Additionally or alternatively, information provider 326 may determine to continue presenting indication 330 until the driver looks at indication 330.

As another example, information provider 326 may determine to provide indications 330 when driver is tired or not alert (and to not provide indications 330 otherwise, for example, based on an assumption that the driver has a good reason to drive away from the center of the lane unless they are tired or inattentive). As yet another example, information provider 326 may determine to provide indications 330 when driver has not driven on a road before (and to not provide indications 330 otherwise, for example, based on an assumption that the driver has experience on the road and knows how best to drive on the road).

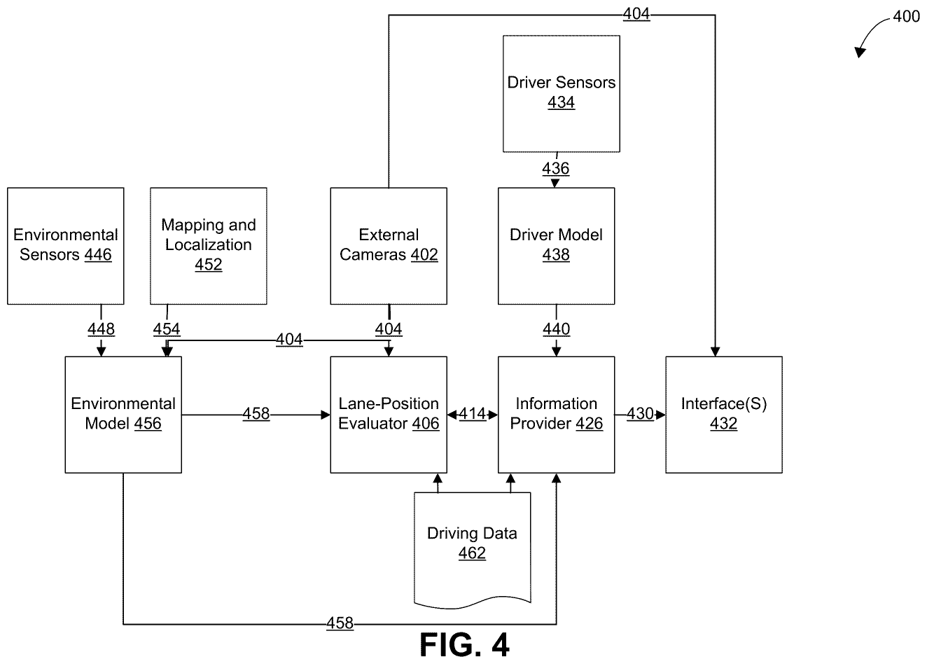

FIG. 4 is a block diagram illustrating an example system 400 for providing recommendations to a driver of a vehicle, according to various aspects of the present disclosure. In general, external cameras 402 may capture image data 404 including a road on which the vehicle is traveling. Additionally, environmental sensors 446 may generate and provide environmental data 448 to environmental model 456. Similarly, mapping and localization 452 may provide location information 454 to environmental model 456. Environmental model 456 may determine environmental information 458 based on image data 404, environmental data 448, and location information 454 and provide environmental information 458 to lane-position evaluator 406. Additionally, in some aspects, system 400 may obtain driving data 462 and provide driving data 462 to lane-position evaluator 406. Lane-position evaluator 406 may determine a position of the vehicle relative to a lane in which the vehicle is traveling. Additionally, lane-position evaluator 406 may determine an appropriateness of the position of the vehicle based on environmental information 458 and/or driving data 462. Further, lane-position evaluator 406 may determine a recommendation 414 based on the position of the vehicle relative to the lane and the appropriateness of the position. Driver sensors 434 may generate driver data 436 based on the driver of the vehicle. Driver model 438 may determine driver information 440 based on driver data 436. Information provider 426 may determine indication 430 of recommendation 414 based on driver information 440 and driving data 462 and provide indication 430 to interface(s) 432.

External cameras 402 may be the same as, may be substantially similar to, and/or may perform the same, or substantially the same, operations as external cameras 202 of FIG. 2. Image data 404 may be the same as, or may be substantially similar to, image data 204 of FIG. 2. Lane-position evaluator 406 may perform the same, or substantially the same, operations as lane-position evaluator 206 of FIG. 2. For example, lane-position evaluator 406 may perform operations described with regard to lane-position evaluator 206, lane-guard module 208, and/or position evaluator 212.

Driver sensors 434 may be the same as, may be substantially similar to, and/or may perform the same, or substantially the same, operations as driver sensors 334 of FIG. 3. Driver data 436 may be the same as, or may be substantially similar to, driver data 336 of FIG. 3. Driver model 438 may be the same as, may be substantially similar to, and/or may perform the same, or substantially the same, operations as driver model 338 of FIG. 3. Driver information 440 may be the same as, or may be substantially similar to, driver information 340 of FIG. 3.

Environmental sensors 446 may be, or may include, one or more sensors configured to generate environmental data 448 based on an environment of the vehicle. Environmental sensors 446 may include cameras, RADAR sensors, LIDAR sensors, and/or other sensors. Environmental data 448 may include data representative of an environment of the vehicle. Environmental data 448 may include representations of objects, vehicles, people, etc. in the environment of the vehicle, for example, on or near the road on which the vehicle is travelling.

Mapping and localization 452 may generate location information 454. Location information 454 may be, or may include, a map of roads and other objects in the environment of the vehicle. Location information 454 may be, or may include, at least a portion of a high-definition (HD) map of the environment, for example, including three-dimensional points representative of the road, lane boundaries, lane lines, crosswalks, street signs, traffic lights, etc. Location information 454 may include points at a sub-meter granularity. Mapping and localization 452 may determine coordinates (e.g., latitude and longitude) describing a location of the vehicle. Further, mapping and localization 452 may obtain an HD map and correlate the location of the vehicle with a portion of the HD map. Location information 454 may be, or may include, a portion of the HD map.

Environmental model 456 may be, or may include, a model of the environment of the vehicle. Environmental model 456 may generate environmental information 458 based on environmental data 448 and location information 454. Environmental data 448 and location information 454 may include raw sensor data and raw map data respectively. Environmental information 458 may include inferences and/or correlations based on environmental data 448 and location information 454. For example, environmental information 458 may include a map of the environment including vehicles and objects.

Environmental information 458 is an example of contextual information. Lane-position evaluator 406 may determine an appropriateness of a position of the vehicle in a lane based on environmental information 458. Additionally or alternatively, lane-position evaluator 406 may determine recommendation 414 based on environmental information 458. For example, environmental information 458 may include information related to positions of dynamic objects (e.g., large trucks, lane splitting motorcycles, etc.) on or near the road, positions of static objects (e.g., debris, stopped vehicles, etc.), curvature of the road, an angle of the road (e.g., whether the road ascends or descends and/or a lateral angle of the road, such as, if the road is angled to the right or left).

Driving data 462 may be, or may include, lane-position data recorded by the vehicle or other vehicles that have traveled in the lane of the road. For example, the vehicle may have traveled on the road before and may have recorded the position of the vehicle relative to the lane while the vehicle traveled on the road. Additionally, other vehicles may have traveled on the road before and recorded the respective positions of the other vehicles as the other vehicles traveled on the road.

Lane-position evaluator 406 may determine trends in driving data 462 and may determine, based on a trend, a safe lane position for the road. For example, if driving data 462 indicates that for a stretch of road, a majority of vehicles (represented in driving data 462) traveled on the right side of the lane, lane-position evaluator 406 may determine that the right side of the lane, for that stretch of road may be safe, or desirable. Accordingly, lane-position evaluator 406 may determine to not recommend that a driver not drive on the right side of the lane in that stretch of road. Additionally or alternatively, lane-position evaluator 406 may determine to recommend that a driver drive on the right side of the lane in that stretch of road.

Information provider 426 may be the same as, may be substantially similar to, and/or may perform the same, or substantially the same, operations as driver-information module 226 of FIG. 2 and/or display-arbitration module 228 of FIG. 2. Indication 430 may be the same as, or may be substantially similar to, indication 230 of FIG. 2. Interface(s) 432 may be the same as, may be substantially similar to, and/or may perform the same, or substantially the same, operations as interface(s) 232 of FIG. 2.

Additionally, in some aspects, information provider 426 may determine indication 430 based on driver information 440, environmental information 458 and/or driving data 462. For example, information provider 426 may determine whether and/or how to present indication 430 of recommendation 414 based on driver information 440, environmental information 458, and/or driving data 462. For example, in some aspects, lane-position evaluator 406 may provide recommendation 414 recommending that a vehicle move to a center of a lane while the vehicle is driving on a given road. However, information provider 426 may determine, based on a majority of vehicles travelling on a right side of a lane while traveling on the given road (e.g., as indicated by driving data 462), to not provide indication 430. Additionally or alternatively, based on a stalled vehicle on the side of the road (e.g., as indicated by environmental information 458), information provider 426 may determine to not provide indication 430. Additionally or alternatively, based on a threat assessment, for example, based on environmental information 458, information provider 426 may determine to escalate or deescalate an indication 430. For example, based on environmental information 458 indicating danger, information provider 426 may escalate indication 430, for example, selecting an attention-grabbing mode of conveying indication 430. For example, information provider 426 may select indication 430 to include a display at a HUD of interface(s) 432 and a vibration at a seat of a driver of the vehicle. Alternatively, based on environmental information 458 indicating no threat, information provider 426 may determine to provide indication 430 as a small graphical representation on a console of the vehicle. Additionally or alternatively, information provider 426 may determine indication 430 based on an alertness of the driver (e.g., as indicated by driver information 440).

Table 1 provides examples of context, driver behavior and prompt modalities.

TABLE 1

| | | Prompt |
|---|---|---|
| Context | Driver Behavior | Modalities |
| dynamic objects (e.g., large | did the driver look at a prior | display on |
| trucks, lane splitting | indication? | console |
| motorcycles) on or near road | | |
| stationary objects, such as | did the driver look at the vehicle or | display at |
| obstacles (e.g., dropped cargo) | object on which the prior | HUD |
| on or near road | recommendation was based? | |
| vehicle or object obstructing the | did the driver adjust the position of | audio |
| driver's view | the vehicle after the prior indication | |
| | was provided? | |
| a vehicle ahead of the vehicle | how long ago was the prior indication | steering- |
| that favors one side of a lane | provided, has the situation changed? | wheel |
| | | vibration |
| road curvature | how did the driver react to previous | seat |
| | recommendations? | vibration |
| speed of vehicle | has the driver driven here before? | take |
| | | control of |
| | | vehicle |

Information provider 426 may determine indication 430 based on information such as the information provided in table 1. For example, the “Context” column of table 1 includes a number of example situations that may be factors in determining whether and/or how to present an indication of a recommendation. For example, a vehicle may be traveling near a lane boundary, for example, not in the center of a lane. Lane-position evaluator 406 may generate a recommendation to move to the center of a lane. Information provider 426 (or lane-position evaluator 406) may deescalate, or determine not to provide, an indication of such a recommendation based on the presence of a dynamic or static object on or near the road because the object may be the reason the driver is not driving in the center of the lane. Alternatively, based on an object partially in the lane in which the vehicle is traveling, lane-position evaluator 406 may recommend moving to a side of the lane. Based on a proximity of the object, and/or the speed of the vehicle, information provider 426 may escalate the recommendation.

The “Driver Behavior” column includes a number of example driver behaviors that may be factors in determining whether and/or how to present an indication of a recommendation. For example, a vehicle may be traveling near a lane boundary, for example, not in the center of a lane. Lane-position evaluator 406 may generate a recommendation to move to the center of a lane. Information provider 426 (or lane-position evaluator 406) may escalate a recommendation if a prior indication of a potentially dangerous situation has not been heeded. For example, if an indication or a recommendation was not looked at, if the driver did not change the position of the vehicle, if the driver did not look at a basis for the recommendation (such as a vehicle or object on or near the road), information provider 426 may determine to provide a more attention-grabbing indication. Alternatively, based on the drier responding promptly and correctly to prior recommendations, information provider 426 may determine to provide more subtle indications to correct lane positions (e.g., in the absence of danger).

The “Prompt Modalities” column includes a number of example modalities (e.g., of interface(s) 432) that can be used to provide indication 430 to a driver. The example modalities are arranged in an example of an order of least attention-grabbing (or most subtle) to most attention grabbing. For example, a display at a HUD may be more attention-grabbing than a display at a console. The modalities may be used in combination. For example, in addition to displaying a graphic at a HUD, information provider 426 may play audio using speakers of the vehicle. Additionally, within the modalities there may be degrees of intensity. For example, graphical representations can be presented in different colors and/or sizes based on the escalation of the recommendation. Additionally or alternatively, audio data may be presented at various volumes and/or using different speakers depending on the escalation of the recommendations.

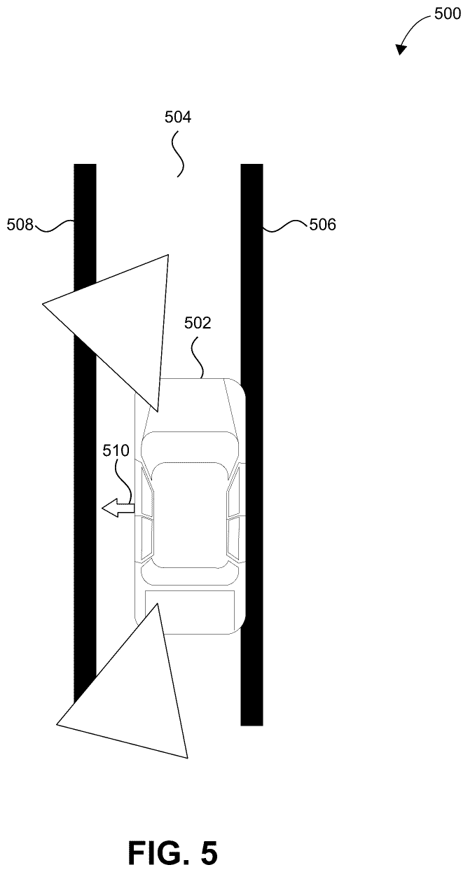

FIG. 5 includes an example graphical representation 500 of a recommendation, according to various aspects of the present disclosure. For example, graphical representation 500 includes a representation of a vehicle 502 and a representation of the position of vehicle 502 relative to a lane 504 in which vehicle 502 is traveling. For instance, graphical representation 500 includes representation of a position of vehicle 502 relative to a right lane boundary 506 and a left lane boundary 508. A graphical representation, such as graphical representation 500 may be displayed at a console display, on a HUD, or an another display of a vehicle. Graphical representation 500 is an example of indication 230 of FIG. 2, indication 330 of FIG. 3, and indication 430 of FIG. 4.

In some aspects, graphical representation 500 may include an arrow 510 indicating a direction to move to center vehicle 502 in lane 504. In some aspects, a size and/or color of one or more elements of graphical representation 500 may be based on a distance of the vehicle from the lane boundary or lane center. For example, arrow 510 may be larger in cases in which a vehicle is farther from the left lane boundary and smaller when the vehicle is closer to the left lane boundary. Additionally or alternatively, arrow 510 may be green if the vehicle is closer to the left lane boundary and red if the vehicle is farther from the left lane boundary.

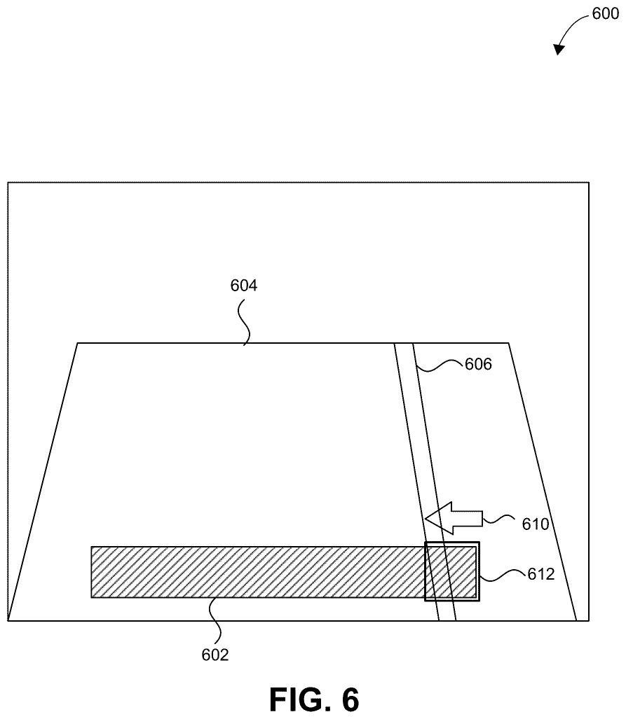

FIG. 6 includes an example graphical representation 600 of a recommendation, according to various aspects of the present disclosure. For example, graphical representation 600 includes a representation of a vehicle 602, a representation of a tire 612 of vehicle 602, a representation of the position of vehicle 602 relative to a lane 604 in which vehicle 602 is traveling. For instance, graphical representation 600 includes representation of a position of vehicle 602 relative to a right lane boundary 606. A graphical representation, such as graphical representation 600 may be displayed at a console display, on a HUD, or an another display of a vehicle. Graphical representation 600 is an example of indication 230 of FIG. 2, indication 330 of FIG. 3, and indication 430 of FIG. 4.

In some aspects, graphical representation 600 may include an arrow 610 indicating a direction to move to center vehicle 602 in lane 604. In some aspects, a size and/or color of one or more elements of graphical representation 600 may be based on a distance of the vehicle from the lane boundary or lane center. For example, arrow 610 may be larger in cases in which a vehicle is closer to or over right lane boundary 606 and smaller when the vehicle is closer to the center of lane 604. Additionally or alternatively, arrow 610 and/or tire 612 may be green if the vehicle is closer to the center of lane 604 and red if the vehicle is closer to or over right lane boundary 606. In some aspects, vehicle 602 may be omitted from graphical representation 600, for example, such that tire 612 is included in graphical representation 600 without vehicle 602.

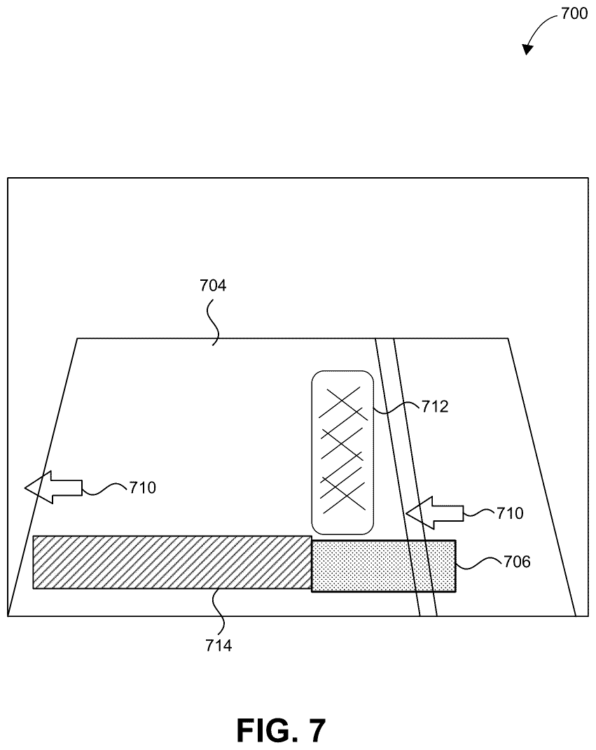

FIG. 7 includes an example graphical representation 700 of a recommendation, according to various aspects of the present disclosure. For example, graphical representation 700 includes a representation of a tire 712 of a vehicle and a representation of the position of tire 712 relative to a lane 704 in which the vehicle is traveling. For instance, graphical representation 700 includes representation of a position of tire 712 relative to a righthand portion side of lane 706 and relative to a center portion side of lane 714. Righthand portion side of lane 706 may be an inappropriate position to drive within lane 704 and center portion side of lane 714 may be an appropriate position to drive within lane 704. A graphical representation, such as graphical representation 700 may be displayed at a console display, on a HUD, or an another display of a vehicle. Graphical representation 700 is an example of indication 230 of FIG. 2, indication 330 of FIG. 3, and indication 430 of FIG. 4. Similar to graphical representation 500 of FIG. 6 and graphical representation 600 of FIG. 6, graphical representation 700 may include one or more arrow(s) 710. The one or more arrow(s) 710 may be sized, positioned, and/or colored based on a position of the vehicle within the lane.

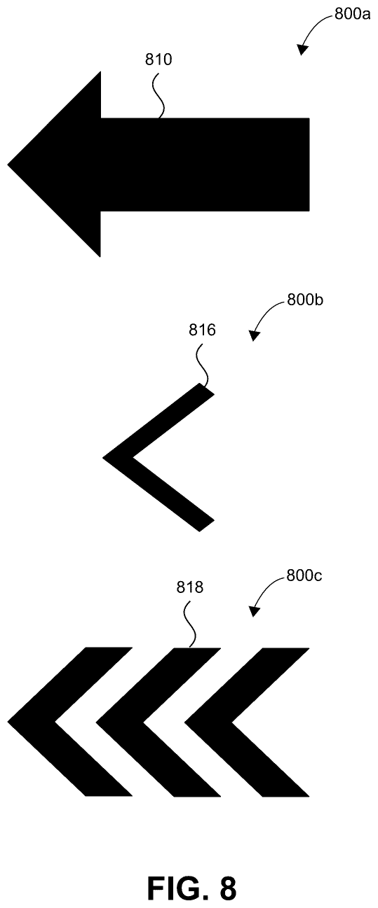

FIG. 8 includes three example graphical representations of respective recommendations, according to various aspects of the present disclosure. For example, graphical representation 800a includes an arrow 810, graphical representation 800b includes a chevron 816, and graphical representation 800c includes three chevrons 818. A graphical representation, such as graphical representation 800a, graphical representation 800b, and/or graphical representation 800c may be displayed at a console display, on a HUD, or an another display of a vehicle. Graphical representation 800a, graphical representation 800b, and graphical representation 800c are examples of indication 230 of FIG. 2, indication 330 of FIG. 3, and indication 430 of FIG. 4. Similar to graphical representation 500 of FIG. 6 and graphical representation 600 of FIG. 6, arrow 810, chevron 816, and chevrons 818 may be sized, positioned, and/or colored based on a position of the vehicle within the lane. Additionally, chevrons 818 may include a number of chevrons based on the position of the vehicle within the lane.

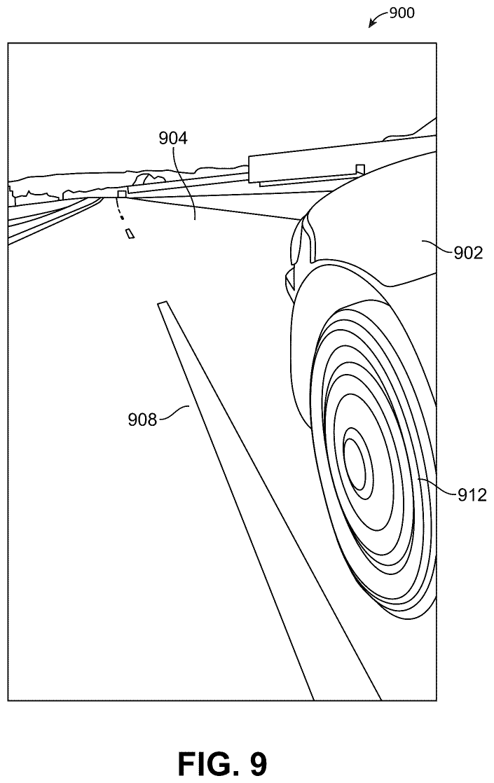

FIG. 9 includes an example representation 900 of a recommendation, according to various aspects of the present disclosure. For example, representation 900 includes an image of a tire 912 of vehicle 902 relative to a lane 904 in which the vehicle is traveling. representation 900 may be an image of a series of images (e.g., of a video) captured by an external camera of vehicle 902. For instance, representation 900 includes tire 912 relative to a left lane boundary 908. A graphical representation, such as representation 900 may be displayed at a console display, on a HUD, or an another display of a vehicle. Representation 900 is an example of indication 230 of FIG. 2, indication 330 of FIG. 3, and indication 430 of FIG. 4. Similar to graphical representation 500 of FIG. 6 and graphical representation 600 of FIG. 6, representation 900 may include one or more arrow(s) 910. The one or more arrow(s) 910 may be sized, positioned, and/or colored based on a position of the vehicle within the lane.

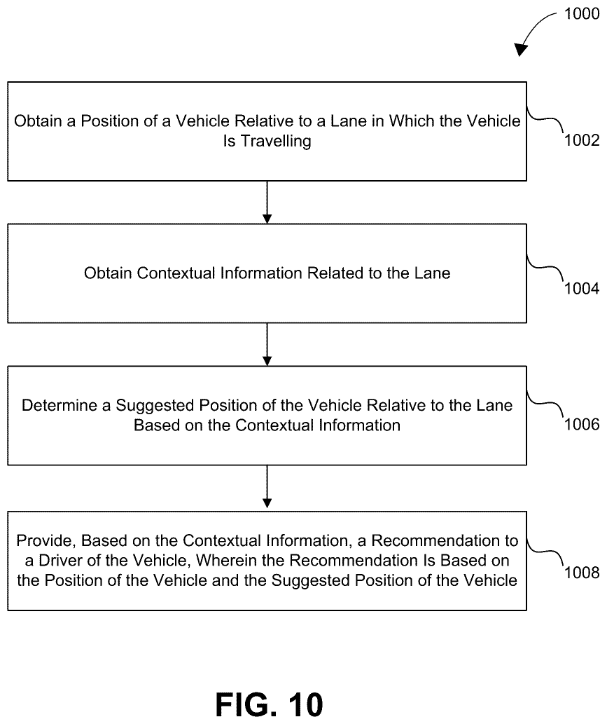

FIG. 10 is a flow diagram illustrating an example process 1000 for providing lane-centering prompts, in accordance with aspects of the present disclosure. One or more operations of process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1000. The one or more operations of process 1000 may be implemented as software components that are executed and run on one or more processors.

At block 1002, a computing device (or one or more components thereof) may obtain a position of a vehicle relative to a lane in which the vehicle is travelling. For example, lane-position evaluator 206, lane-guard module 208, and/or position evaluator 212 may determine a position of a vehicle relative to a lane in which the vehicle is traveling, for example, based on image data 204.

At block 1004, the computing device (or one or more components thereof) may obtain contextual information related to the lane. For example, lane-position evaluator 206 and/or position evaluator 212 may obtain contextual information 224.

At block 1006, the computing device (or one or more components thereof) may determine a suggested position of the vehicle relative to the lane based on the contextual information. For example, position evaluator 212 may determine a suggested position for the vehicle relative to the lane based on contextual information 224.

In some aspects, the suggested position of the vehicle may be in a center of the lane.

In some aspects, the suggested position of the vehicle may be offset from a center of the lane.

At block 1008, the computing device (or one or more components thereof) may provide, based on the contextual information, a recommendation to a driver of the vehicle, wherein the recommendation is based on the position of the vehicle and the suggested position of the vehicle. For example, position evaluator 212 may determine recommendation 214. Additionally, based on contextual information 224, driver-information module 226 may cause display-arbitration module 228 to provide recommendation 214 to the driver using interface(s) 232.

In some aspects, the recommendation may be, or may include, an indication of a distance between the suggested position of the vehicle and the position of the vehicle.

In some aspects, the indication may be, or may include, a visual representation of the distance between the suggested position of the vehicle and the position of the vehicle. For example, the indication may be displayed as illustrated by FIG. 6, FIG. 7, FIG. 8, or FIG. 9.

In some aspects, a color of at least a portion of the visual representation is based on the distance between the suggested position of the vehicle and the position of the vehicle. For example, a portion of the indication illustrated by FIG. 6, FIG. 7, FIG. 8, or FIG. 9 may be colored based on the distance between the current position of the vehicle and the suggested position of the vehicle.

In some aspects, the recommendation may be, or may include, an indication of a distance between a lane boundary and the position of the vehicle.

In some aspects, the indication may be, or may include, a visual representation of the distance between the lane boundary and the position of the vehicle. For example, the indication may be displayed as illustrated by FIG. 6, FIG. 7, FIG. 8, or FIG. 9.

In some aspects, a color of at least a portion of the visual representation is based on the distance between the lane boundary and the position of the vehicle. For example, a portion of the indication illustrated by FIG. 6, FIG. 7, FIG. 8, or FIG. 9 may be colored based on the distance between the current position of the vehicle and the lane boundary.

In some aspects, the recommendation may be, or may include, an indication of a distance between a center of the lane and the position of the vehicle.

In some aspects, the indication may be, or may include, a visual representation of the distance between the center of the lane and the position of the vehicle. For example, the indication may be displayed as illustrated by FIG. 6, FIG. 7, FIG. 8, or FIG. 9.

In some aspects, a color of at least a portion of the visual representation is based on the distance between the center of the lane and the position of the vehicle. For example, a portion of the indication illustrated by FIG. 6, FIG. 7, FIG. 8, or FIG. 9 may be colored based on the distance between the current position of the vehicle and the center of the lane.

In some aspects, the recommendation may be, or may include, at least one of: a visual indication; an audible indication; or a haptic indication. For example, interface(s) 232 may include displays, speakers, and/or actuators that may provide the indication to the driver.

In some aspects, to provide the recommendation to the driver, the computing device (or one or more components thereof) may cause at least one of: illumination of a light source in an instrument panel of the vehicle; display of a visual indication at a display of the vehicle; display of a visual indication at a heads-up display of the vehicle; illumination of a portion of a steering wheel of the vehicle; playing of audio using speakers of the vehicle; pulsing of brakes of the vehicle; vibration of the steering wheel; vibration of a seat belt of the vehicle; or vibration of a seat of the vehicle. For example, interface(s) 232 may include displays, speakers, and/or actuators that may provide the indication to the driver.

In some aspects, the contextual information may be, or may include, information regarding at least one of: another vehicle in the lane; another vehicle proximate to the lane; another vehicle in an adjacent lane; an object in the lane; an object proximate to the lane; an object in an adjacent lane; a field of view of the driver from the position relative to the lane; a curvature of the lane; a speed of the vehicle; a speed limit related to the lane; an alertness of the driver; a manner in which the driver controls a steering wheel of the vehicle; a determined familiarity of the driver with the lane; or conditions of respective tires of the vehicle. For example, contextual information 224 may be, or may include, information including or based on any of: another vehicle in the lane, another vehicle proximate to the lane, another vehicle in an adjacent lane, an object in the lane, an object proximate to the lane, an object in an adjacent lane, a field of view of the driver from the position relative to the lane, a curvature of the lane, a speed of the vehicle, a speed limit related to the lane, an alertness of the driver, a manner in which the driver controls a steering wheel of the vehicle, a determined familiarity of the driver with the lane, and/or conditions of respective tires of the vehicle.

In some aspects, the computing device (or one or more components thereof) may determine a response of the driver to the recommendation; and adjust parameters for providing future recommendations based on the response. To determine the response, the computing device (or one or more components thereof) may determine at least one of: whether the driver looked at the recommendation; whether the driver looked at a side-view mirror of the vehicle after the recommendation was provided; whether the driver changed the position of the vehicle relative to the lane after the recommendation was provided; whether the driver looked at another vehicle proximate to the lane after the recommendation was provided; whether the driver looked at an object proximate to the lane after the recommendation was provided; or a facial expression of the driver after the recommendation was provided.

In some aspects, the recommendation may be a first recommendation. The first recommendation may be provided based on the position of the vehicle relative to the lane satisfying a first threshold. The computing device (or one or more components thereof) may provide a second recommendation based on the position of the vehicle relative to the lane satisfying a second threshold. The second recommendation is of a different type than the first recommendation. For example, when the vehicle comes with a first threshold distance of the lane boundary, the computing device (or one or more components thereof) may provide a visual indication at a first display. When the vehicle comes within a second threshold distance of the lane boundary (e.g., closer to the lane boundary than the first threshold distance), the computing device (or one or more components thereof) may provide a second indication, for example, a visual indication at a second display or an audio indication.

In some aspects, the computing device (or one or more components thereof) may adjust, based on the position, steering of the vehicle. For example, the computing device (or one or more components thereof) may take control of at least steering of the vehicle.

In some aspects, the recommendation is provided based on the position of the vehicle relative to the lane satisfying a first threshold. The computing device (or one or more components thereof) may adjust, based on the position of the vehicle relative to the lane satisfying a second threshold, steering of the vehicle. For example, when a vehicle is a first threshold distance from a lane edge, the computing device (or one or more components thereof) may provide an indication. When the vehicle is a second threshold distance from the lane edge (e.g., closer than the first threshold distance), the computing device (or one or more components thereof) may take control of at least steering of the vehicle.

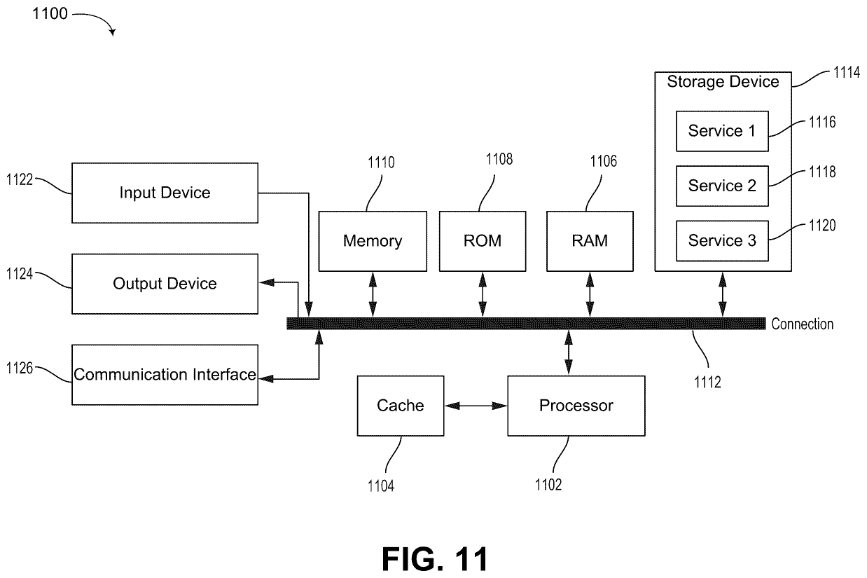

In some examples, as noted previously, the methods described herein (e.g., process 1000 of FIG. 10, and/or other methods described herein) can be performed, in whole or in part, by a computing device or apparatus. In one example, one or more of the methods can be performed by system 200 of FIG. 2, system 300 of FIG. 3, system 400 of FIG. 4, or by another system or device. In another example, one or more of the methods (e.g., process 1000, and/or other methods described herein) can be performed, in whole or in part, by the computing-device architecture 1100 shown in FIG. 11. For instance, a computing device with the computing-device architecture 1100 shown in FIG. 11 can include, or be included in, the components of the system 200, system 300, and/or system 400 and can implement the operations of process 1000, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1000, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1000, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of system 200 of FIG. 2, system 300 of FIG. 3, system 400 of FIG. 4 and/or other devices, modules, or systems described herein. Additionally or alternatively, computing-device architecture 1100 may be configured to perform process 1000, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for providing lane-centering prompts to a driver, the apparatus comprising: at least one memory; and at least one processor coupled to the at least one memory and configured to: obtain a position of a vehicle relative to a lane in which the vehicle is travelling; obtain contextual information related to the lane; determine a suggested position of the vehicle relative to the lane based on the contextual information; and provide, based on the contextual information, a recommendation to a driver of the vehicle, wherein the recommendation is based on the position of the vehicle and the suggested position of the vehicle.

Aspect 2. The apparatus of aspect 1, wherein the suggested position of the vehicle is in a center of the lane.

Aspect 3. The apparatus of any one of aspects 1 or 2, wherein the suggested position of the vehicle is offset from a center of the lane.

Aspect 4. The apparatus of any one of aspects 1 to 3, wherein the recommendation comprises an indication of a distance between the suggested position of the vehicle and the position of the vehicle.

Aspect 5. The apparatus of aspect 4, wherein the indication comprises a visual representation of the distance between the suggested position of the vehicle and the position of the vehicle.

Aspect 6. The apparatus of aspect 5, wherein a color of at least a portion of the visual representation is based on the distance between the suggested position of the vehicle and the position of the vehicle.

Aspect 7. The apparatus of any one of aspects 1 to 6, wherein the recommendation comprises an indication of a distance between a lane boundary and the position of the vehicle.

Aspect 8. The apparatus of aspect 7, wherein the indication comprises a visual representation of the distance between the lane boundary and the position of the vehicle.

Aspect 9. The apparatus of aspect 8, wherein a color of at least a portion of the visual representation is based on the distance between the lane boundary and the position of the vehicle.

Aspect 10. The apparatus of any one of aspects 1 to 9, wherein the recommendation comprises an indication of a distance between a center of the lane and the position of the vehicle.

Aspect 11. The apparatus of aspect 10, wherein the indication comprises a visual representation of the distance between the center of the lane and the position of the vehicle.

Aspect 12. The apparatus of aspect 11, wherein a color of at least a portion of the visual representation is based on the distance between the center of the lane and the position of the vehicle.

Aspect 13. The apparatus of any one of aspects 1 to 12, wherein the recommendation comprises at least one of: a visual indication; an audible indication; or a haptic indication.

Aspect 14. The apparatus of any one of aspects 1 to 13, wherein the contextual information comprises information regarding at least one of: another vehicle in the lane; another vehicle proximate to the lane; another vehicle in an adjacent lane; an object in the lane; an object proximate to the lane; an object in an adjacent lane; a field of view of the driver from the position relative to the lane; a curvature of the lane; a speed of the vehicle; a speed limit related to the lane; an alertness of the driver; a manner in which the driver controls a steering wheel of the vehicle; a determined familiarity of the driver with the lane; or conditions of respective tires of the vehicle.

Aspect 15. The apparatus of any one of aspects 1 to 14, wherein the at least one processor is configured to: determine a response of the driver to the recommendation; and adjust parameters for providing future recommendations based on the response; wherein, to determine the response, the at least one processor is configured to determine at least one of: whether the driver looked at the recommendation; whether the driver looked at a side-view mirror of the vehicle after the recommendation was provided; whether the driver changed the position of the vehicle relative to the lane after the recommendation was provided; whether the driver looked at another vehicle proximate to the lane after the recommendation was provided; whether the driver looked at an object proximate to the lane after the recommendation was provided; or a facial expression of the driver after the recommendation was provided.

Aspect 16. The apparatus of any one of aspects 1 to 15, wherein, to provide the recommendation to the driver, the at least one processor is configured to cause at least one of: illumination of a light source in an instrument panel of the vehicle; display of a visual indication at a display of the vehicle; display of a visual indication at a heads-up display of the vehicle; illumination of a portion of a steering wheel of the vehicle; playing of audio using speakers of the vehicle; pulsing of brakes of the vehicle; vibration of the steering wheel; vibration of a seat belt of the vehicle; or vibration of a seat of the vehicle.

Aspect 17. The apparatus of any one of aspects 1 to 16, wherein the recommendation comprises a first recommendation and wherein the first recommendation is provided based on the position of the vehicle relative to the lane satisfying a first threshold; wherein the at least one processor is configured to provide a second recommendation based on the position of the vehicle relative to the lane satisfying a second threshold, wherein the second recommendation is of a different type than the first recommendation.

Aspect 18. The apparatus of any one of aspects 1 to 17, wherein the at least one processor is configured to adjust, based on the position, steering of the vehicle.

Aspect 19. The apparatus of any one of aspects 1 to 18, wherein the recommendation is provided based on the position of the vehicle relative to the lane satisfying a first threshold; wherein the at least one processor is configured to adjust, based on the position of the vehicle relative to the lane satisfying a second threshold, steering of the vehicle.

Aspect 20. A method for providing lane-centering prompts to a driver, the method comprising: obtaining a position of a vehicle relative to a lane in which the vehicle is travelling; obtaining contextual information related to the lane; determining a suggested position of the vehicle relative to the lane based on the contextual information; and providing, based on the contextual information, a recommendation to a driver of the vehicle, wherein the recommendation is based on the position of the vehicle and the suggested position of the vehicle.

Aspect 21. The method of aspect 20, wherein the suggested position of the vehicle is in a center of the lane.

Aspect 22. The method of any one of aspects 20 or 21, wherein the suggested position of the vehicle is offset from a center of the lane.

Aspect 23. The method of any one of aspects 20 to 22, wherein the recommendation comprises an indication of a distance between the suggested position of the vehicle and the position of the vehicle.

Aspect 24. The method of aspect 23, wherein the indication comprises a visual representation of the distance between the suggested position of the vehicle and the position of the vehicle.

Aspect 25. The method of aspect 24, wherein a color of at least a portion of the visual representation is based on the distance between the suggested position of the vehicle and the position of the vehicle.

Aspect 26. The method of any one of aspects 20 to 25, wherein the recommendation comprises an indication of a distance between a lane boundary and the position of the vehicle.

Aspect 27. The method of aspect 26, wherein the indication comprises a visual representation of the distance between the lane boundary and the position of the vehicle.

Aspect 28. The method of aspect 27, wherein a color of at least a portion of the visual representation is based on the distance between the lane boundary and the position of the vehicle.

Aspect 29. The method of any one of aspects 20 to 28, wherein the recommendation comprises an indication of a distance between a center of the lane and the position of the vehicle.

Aspect 30. The method of aspect 29, wherein the indication comprises a visual representation of the distance between the center of the lane and the position of the vehicle.

Aspect 31. The method of aspect 30, wherein a color of at least a portion of the visual representation is based on the distance between the center of the lane and the position of the vehicle.

Aspect 32. The method of any one of aspects 20 to 31, wherein the recommendation comprises at least one of: a visual indication; an audible indication; or a haptic indication.

Aspect 33. The method of any one of aspects 20 to 32, wherein the contextual information comprises information regarding at least one of: another vehicle in the lane; another vehicle proximate to the lane; another vehicle in an adjacent lane; an object in the lane; an object proximate to the lane; an object in an adjacent lane; a field of view of the driver from the position relative to the lane; a curvature of the lane; a speed of the vehicle; a speed limit related to the lane; an alertness of the driver; a manner in which the driver controls a steering wheel of the vehicle; a determined familiarity of the driver with the lane; or conditions of respective tires of the vehicle.

Aspect 34. The method of any one of aspects 20 to 33, further comprising: determining a response of the driver to the recommendation; and adjusting parameters for providing future recommendations based on the response; wherein determining the response comprises determining at least one of: whether the driver looked at the recommendation; whether the driver looked at a side-view mirror of the vehicle after the recommendation was provided; whether the driver changed the position of the vehicle relative to the lane after the recommendation was provided; whether the driver looked at another vehicle proximate to the lane after the recommendation was provided; whether the driver looked at an object proximate to the lane after the recommendation was provided; or a facial expression of the driver after the recommendation was provided.

Aspect 35. The method of any one of aspects 20 to 34, wherein providing the recommendation to the driver comprises at least one of: illuminating a light source in an instrument panel of the vehicle; displaying a visual indication at a display of the vehicle; displaying a visual indication at a heads-up display of the vehicle; illuminating a portion of a steering wheel of the vehicle; playing audio using speakers of the vehicle; pulsing brakes of the vehicle; vibrating the steering wheel; vibrating a seat belt of the vehicle; or vibrating a seat of the vehicle.

Aspect 36. The method of any one of aspects 20 to 35, wherein the recommendation comprises a first recommendation and wherein the first recommendation is provided based on the position of the vehicle relative to the lane satisfying a first threshold; further comprising: providing a second recommendation based on the position of the vehicle relative to the lane satisfying a second threshold, wherein the second recommendation is of a different type than the first recommendation.

Aspect 37. The method of any one of aspects 20 to 36, further comprising adjusting, based on the position, steering of the vehicle.

Aspect 38. The method of any one of aspects 20 to 37, wherein the recommendation is provided based on the position of the vehicle relative to the lane satisfying a first threshold; further comprising: adjusting, based on the position of the vehicle relative to the lane satisfying a second threshold, steering of the vehicle.

Aspect 39. A non-transitory computer-readable storage medium having stored thereon instructions that, when executed by at least one processor, cause the at least one processor to perform operations according to any of aspects 20 to 38.

Aspect 40. An apparatus for providing virtual content for display, the apparatus comprising one or more means for perform operations according to any of aspects 20 to 38.

What is claimed is:

1. An apparatus for providing lane-centering prompts to a driver, the apparatus comprising:
at least one memory; and
at least one processor coupled to the at least one memory and configured to:
obtain a position of a vehicle relative to a lane in which the vehicle is travelling;
obtain contextual information related to the lane;
determine a suggested position of the vehicle relative to the lane based on the contextual information; and
provide, based on the contextual information, a recommendation to a driver of the vehicle, wherein the recommendation is based on the position of the vehicle and the suggested position of the vehicle.

2. The apparatus of claim 1, wherein the suggested position of the vehicle is in a center of the lane.

3. The apparatus of claim 1, wherein the suggested position of the vehicle is offset from a center of the lane.

4. The apparatus of claim 1, wherein the recommendation comprises an indication of a distance between the suggested position of the vehicle and the position of the vehicle.

5. The apparatus of claim 4, wherein the indication comprises a visual representation of the distance between the suggested position of the vehicle and the position of the vehicle.

6. The apparatus of claim 5, wherein a color of at least a portion of the visual representation is based on the distance between the suggested position of the vehicle and the position of the vehicle.

7. The apparatus of claim 1, wherein the recommendation comprises an indication of a distance between a lane boundary and the position of the vehicle.

8. The apparatus of claim 7, wherein the indication comprises a visual representation of the distance between the lane boundary and the position of the vehicle.

9. The apparatus of claim 8, wherein a color of at least a portion of the visual representation is based on the distance between the lane boundary and the position of the vehicle.

10. The apparatus of claim 1, wherein the recommendation comprises an indication of a distance between a center of the lane and the position of the vehicle.

11. The apparatus of claim 10, wherein the indication comprises a visual representation of the distance between the center of the lane and the position of the vehicle.

12. The apparatus of claim 11, wherein a color of at least a portion of the visual representation is based on the distance between the center of the lane and the position of the vehicle.

13. The apparatus of claim 1, wherein the recommendation comprises at least one of:
a visual indication;
an audible indication; or
a haptic indication.

14. The apparatus of claim 1, wherein the contextual information comprises information regarding at least one of:
another vehicle in the lane;
another vehicle proximate to the lane;
another vehicle in an adjacent lane;
an object in the lane;
an object proximate to the lane;
an object in an adjacent lane;
a field of view of the driver from the position relative to the lane;
a curvature of the lane;
a speed of the vehicle;
a speed limit related to the lane;
an alertness of the driver;
a manner in which the driver controls a steering wheel of the vehicle;
a determined familiarity of the driver with the lane; or
conditions of respective tires of the vehicle.

15. The apparatus of claim 1, wherein the at least one processor is configured to:
determine a response of the driver to the recommendation; and
adjust parameters for providing future recommendations based on the response;
wherein, to determine the response, the at least one processor is configured to determine at least one of:
whether the driver looked at the recommendation;
whether the driver looked at a side-view mirror of the vehicle after the recommendation was provided;
whether the driver changed the position of the vehicle relative to the lane after the recommendation was provided;
whether the driver looked at another vehicle proximate to the lane after the recommendation was provided;
whether the driver looked at an object proximate to the lane after the recommendation was provided; or
a facial expression of the driver after the recommendation was provided.

16. The apparatus of claim 1, wherein, to provide the recommendation to the driver, the at least one processor is configured to cause at least one of:
illumination of a light source in an instrument panel of the vehicle;
display of a visual indication at a display of the vehicle;
display of a visual indication at a heads-up display of the vehicle;
illumination of a portion of a steering wheel of the vehicle;
playing of audio using speakers of the vehicle;
pulsing of brakes of the vehicle;
vibration of the steering wheel;
vibration of a seat belt of the vehicle; or
vibration of a seat of the vehicle.

17. The apparatus of claim 1, wherein the recommendation comprises a first recommendation and wherein the first recommendation is provided based on the position of the vehicle relative to the lane satisfying a first threshold;
wherein the at least one processor is configured to provide a second recommendation based on the position of the vehicle relative to the lane satisfying a second threshold, wherein the second recommendation is of a different type than the first recommendation.

18. The apparatus of claim 1, wherein the at least one processor is configured to adjust, based on the position, steering of the vehicle.

19. The apparatus of claim 1, wherein the recommendation is provided based on the position of the vehicle relative to the lane satisfying a first threshold;
wherein the at least one processor is configured to adjust, based on the position of the vehicle relative to the lane satisfying a second threshold, steering of the vehicle.

20. A method for providing lane-centering prompts to a driver, the method comprising:
obtaining a position of a vehicle relative to a lane in which the vehicle is travelling;
obtaining contextual information related to the lane;
determining a suggested position of the vehicle relative to the lane based on the contextual information; and
providing, based on the contextual information, a recommendation to a driver of the vehicle, wherein the recommendation is based on the position of the vehicle and the suggested position of the vehicle.
